(19) United States
(12) Patent Application Publication
(10) Pub. No.: US 2013/0257808 A1
(43) Pub. Date: Oct. 3, 2013

(54) OPTICAL TOUCH APPARATUS

(71) Applicants: Hui-Hsuan CHEN, Hsinchu (TW); Chia-Hsin YU, Hsinchu (TW); Hung-Ching LAI, Hsinchu (TW)

(72) Inventors: Hui-Hsuan CHEN, Hsinchu (TW); Chia-Hsin YU, Hsinchu (TW); Hung-Ching LAI, Hsinchu (TW)

(73) Assignee: PixArt Imaging Inc., Hsinchu City (TW)

(21) Appl. No.: 13/528,761

(22) Filed: Jun. 20, 2012

(30) Foreign Application Priority Data
Mar. 28, 2012 (TW) 101110863

(51) Int. Cl. G06F 3/042

(52) U.S. Cl. 345/175

(57) ABSTRACT

An optical touch apparatus includes a base, a light source and a light sensing element. The base is constituted by a bottom wall, a plurality of sidewalls and at least one supporting part. The sidewalls are connected to the bottom wall. The sidewalls and the bottom wall corporately form an accommodation space. The at least one supporting part is connected to at least one of the sidewalls and extends from at least one of the connected sidewall(s) in a direction away from the accommodation space. The light source and the light sensing element are disposed on the at least one supporting part.

### TECHNICAL FIELD

The present invention relates to a touch apparatus, and more particularly to an optical touch apparatus.

### BACKGROUND

Due to having advantages e.g. easy-to-operation, in recent years touch apparatuses have been widely used in a variety of electronic products, such as mobile phones, digital cameras, music players, tablet computers, satellite navigation devices and touch panels. Basically, the present touch apparatuses can be categorized to: resistive type, capacitive type and optical type. Because having a relatively better durability and a lower cost, optical touch apparatuses accordingly have drawn more and more attention.

FIG. 1 is a schematic structural view of an optical touch apparatus of prior art. As shown, the conventional optical touch apparatus 100 includes a display panel 110, a glass substrate 120, an optical touch module 130 and a base 140. Specifically, the display panel 110 is disposed in an accommodation space 142 of the base 140; the glass substrate 120 is fixed on the display panel 110; and the optical touch module 130 is fixed on the glass substrate 120.

Conventionally, the components (for example, the light sensing element, the light source, etc.) of the optical touch module 130 are directly disposed on the glass substrate 120. However, the glass substrate 120 disposed on the display panel 110 may reduce the light transmittance of the display panel 110 or result in light reflections.

### SUMMARY OF EMBODIMENTS

Therefore, one object of the present invention is to provide an optical touch apparatus, and the components, such as the light source and the light sensing element, of the optical touch module are supported by a base.

The present invention provides an optical touch apparatus, which includes a base, a light source and a light sensing element. The base is constituted by a bottom wall, a plurality of sidewalls and at least one supporting part. The sidewalls are connected to the bottom wall. The sidewalls and the bottom wall corporately form an accommodation space. The at least one supporting part is connected to at least one of the sidewalls and extends from at least one of the connected sidewall(s) in a direction away from the accommodation space. The light source and the light sensing element are disposed on the at least one supporting part.

In an embodiment of the present invention, the supporting part includes a first wall, a second wall and a third wall. The first wall is connected to its corresponding sidewall. The first wall and the second wall are opposite to each other. The third wall is connected between the first wall and the second wall. The first wall, the second wall and the third wall corporately form an accommodation groove.

In an embodiment of the present invention, the aforementioned optical touch apparatus further includes a light guide strip disposed in the accommodation groove. The light guide strip has a light-incidence surface and a light-emission surface adjacent to the light-incidence surface. The light-emission surface is configured to face to the accommodation space. The light source is disposed beside the light-incidence surface.

In an embodiment of the present invention, the aforementioned optical touch apparatus further includes a light filtering component disposed on the light-emission surface of the light guide strip.

In an embodiment of the present invention, the aforementioned optical touch apparatus further includes a light filtering component configured to cover the second wall and the light-emission surface of the light guide strip.

In an embodiment of the present invention, the aforementioned optical touch apparatus further includes a reflective strip disposed in the accommodation groove. The reflective strip has a reflective surface facing to the accommodation space.

In an embodiment of the present invention, the aforementioned optical touch apparatus further includes a light filtering component disposed on the reflective surface of the reflective strip.

In an embodiment of the present invention, the aforementioned optical touch apparatus further includes a light filtering component configured to cover the second wall and the reflective surface of the reflective strip.

In an embodiment of the present invention, the aforementioned optical touch apparatus further includes a reflective layer disposed on the surfaces, facing to the accommodation groove, of the first wall, the second wall and the third wall.

In an embodiment of the present invention, the supporting part has a plate structure. The aforementioned optical touch apparatus further includes a reflective film disposed on the plate. The reflective film includes a fourth wall, a fifth wall and a sixth wall. The fourth wall is disposed on the plate. The fourth wall and the fifth wall are opposite to each other. The sixth wall is connected between the fourth wall and the fifth wall. The fourth wall, the fifth wall and the sixth wall corporately form an accommodation groove. In addition, the aforementioned optical touch apparatus further includes a light guide strip disposed in the accommodation groove. The light guide strip has a light-incidence surface and a light-emission surface adjacent to the light-incidence surface. The light-emission surface is configured to face to the accommodation space. The light source is disposed beside the light-incidence surface. In addition, the aforementioned optical touch apparatus further includes a light filtering component disposed on the light-emission surface of the light guide strip. The light filtering component is configured to cover the fifth wall and the light-emission surface of the light guide strip in another embodiment.

In an embodiment of the present invention, the base is made of a metal plate processed by a stamping production mean.

In an embodiment of the present invention, the aforementioned optical touch apparatus further includes a display panel disposed in the the accommodation space.

In an embodiment of the present invention, the aforementioned optical touch apparatus further includes a reflective layer disposed on the surfaces, facing to the accommodation space, of the bottom wall and the sidewalls.

In summary, because the base in the optical touch apparatus according to the present invention includes the supporting part, the components, such as the light source and the light sensing element of the optical touch module can be supported by the supporting part.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic structural view of an optical touch apparatus of prior art;

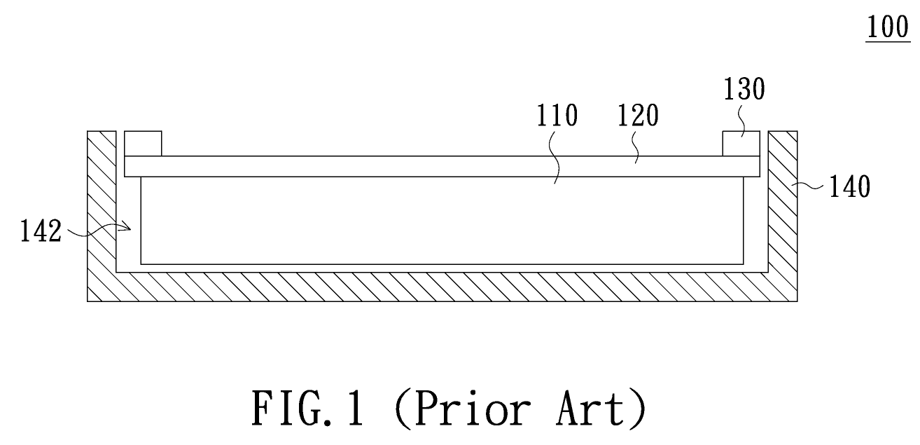

FIG. 2 is a schematic top view of an optical touch apparatus in accordance with an embodiment of the present invention;

FIG. 3 is a schematic cross-sectional view of the optical touch apparatus shown in the FIG. 2 along a line A-A;

FIG. 4 is a schematic partial cross-sectional view of an optical touch apparatus in accordance with another embodiment of the present invention;

FIG. 5 is a schematic top view of an optical touch apparatus in accordance with another embodiment of the present invention; and

FIG. 6 is a schematic partial cross-sectional view of an optical touch apparatus in accordance with another embodiment of the present invention.

### DETAILED DESCRIPTION OF PREFERRED EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

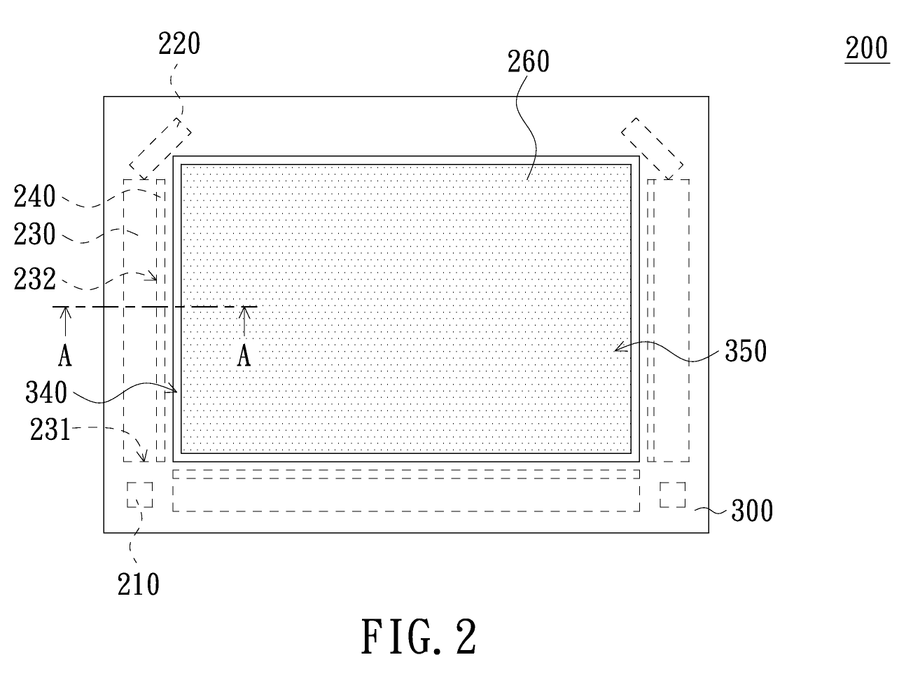

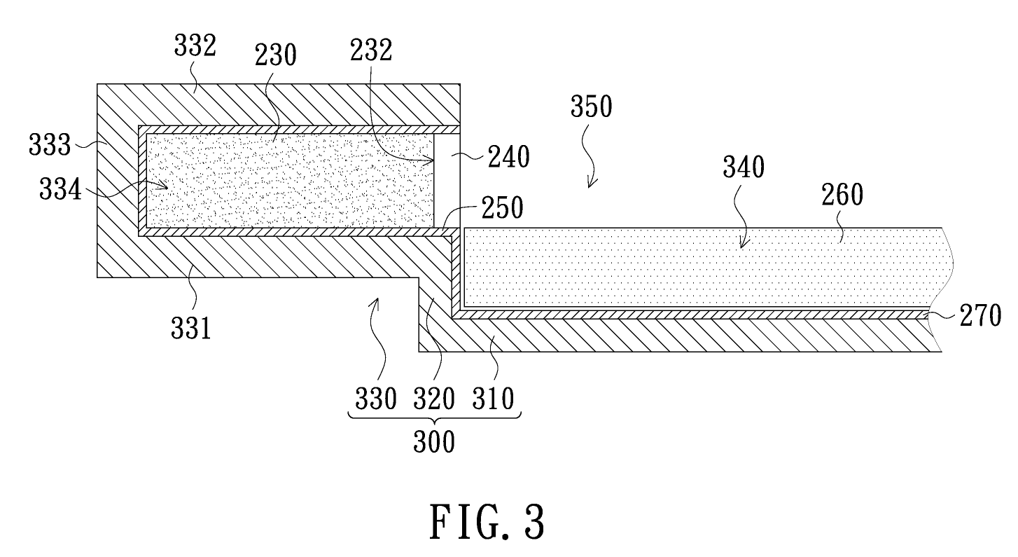

FIG. 2 is a schematic top view of an optical touch apparatus in accordance with an embodiment of the present invention; and FIG. 3 is a schematic cross-sectional view of the optical touch apparatus shown in the FIG. 2 along a line A-A. Please refer to FIGS. 2, 3 both. The optical touch apparatus 200 in this embodiment includes a light source 210, a light sensing element 220 and a base 300. The base 300 includes a bottom wall 310, a plurality of sidewalls 320 and at least one supporting part 330. The sidewalls 320 each are connected to the bottom wall 310, and the sidewalls 320 and the bottom wall 310 corporately form an accommodation space 340 therebetween. The at least one supporting part 330 is connected to at least one of the sidewalls 320 and extends from at least one of the connected sidewall(s) 320 in a direction away from the accommodation space 340. In this embodiment, the base 300 is exemplified by including more than one supporting part 330 configured to be connected to the sidewalls 320; and specifically, each sidewall 320 is connected to one supporting part 330 only. It is understood that each sidewall 320 may be connected to more than one supporting part 330 in another embodiment; and the base 300 may include one supporting part 330 only in still another embodiment. In addition, the optical touch apparatus 200 further includes a plate 260 disposed in the accommodation space 340; wherein the plate 260 is, for example, a display panel, a glass substrate or a plastic substrate, and on a surface the plate 260 a user can perform specific operations.

The light source 210 and the light sensing element 220 are disposed on the at least one supporting part 330. Specifically, the light source 210 and the light sensing element 220 can be disposed on a same supporting part 330, or disposed on two different supporting parts 330 (for example, two adjacent supporting parts 330). In this embodiment, the optical touch apparatus 200 is exemplified by including two light sources 210 and two light sensing elements 220, and no limitation. In other embodiments, the optical touch apparatus 200 may include one or more than two light sources 210 and one or more than two light sensing elements 220; wherein the number of the light sources 210 is not necessary to be same as that of the light sensing elements 220.

The supporting part 330 includes a first wall 331, a second wall 332 and a third wall 333. Specifically, the first wall 331 is connected to its corresponding sidewall 320; the first wall 331 and the second wall 332 are opposite to each other; and the third wall 333 is connected between the first wall 331 and the second wall 332. The first wall 331, the second wall 332 and the third wall 333 corporately form an accommodation groove 334, in which the associated light source 210 and the associated light sensing element 220 are disposed. In addition, the base 300 in this embodiment is made of one metal plate processed by a stamping production mean, and no limitation.

In this embodiment, the optical touch apparatus 200 further includes a light guide strip 230, which is disposed in the accommodation groove 334. The light guide strip 230 has a light-incidence surface 231 and a light-emission surface 232. Specifically, the light-incidence surface 231 and the light-emission surface 232 are adjacent to each other; the light-emission surface 232 is configured to face to the accommodation space 340; and the light source 210 is disposed beside the light-incidence surface 231. The number of the light guide strip 230 is based on actual requirements; and the optical touch apparatus 200 in this embodiment is exemplified by including three light guide strips 230, which corporately define a sensing region 350. The light source 210 is configured to provide light, which is then directed into the sensing region 350 sequentially through the light-incidence surface 231, the internal of the light guide strip 230 and the light-emission surface 232. The light source 210 is, for example, a light emitting diode (LED), a laser diode or other types of suitable light source; and the light provided by the light source 210 is infrared light, and no limitation. In addition, the light sensing element 220 is configured to sense the light in the sensing region 350 and can be implemented by a complementary metal oxide semiconductor (CMOS) image sensor, charge coupled device (CCD) or other types of suitable light-sensing device. The touch sensing process and method associated with the optical touch apparatus 200 are apparent to those ordinarily skilled in the art; no any unnecessary detail will be given here.

To enhance the sensing effect and accuracy, the optical touch apparatus 200 further includes a light-filtering component 240 disposed on the light-emission surface 232 of the light guide strip 230 and configured to filter out the light emitted into the sensing region 350 except the light provided by the light source 210. In other words, in the embodiment of the light source 210 configured to provide infrared light, the light-filtering component 240 is capable of being passed through by infrared light and filters out the light except the infrared light. In addition, to increase the light-usage efficiency, the optical touch apparatus 200 may further include a reflective layer 250, which is disposed on the surfaces (facing to the accommodation groove 334) of the first wall 331, the second wall 332 and the third wall 333. It is to be noted that another reflective layer 270 can be disposed on the surfaces (facing to the accommodation space 340) of the bottom wall 310 and the sidewalls 320 of the base 300 based actual requirements.

As shown in FIGS. 2, 3, without being disposed on the plate 260, in the optical touch apparatus 200 of this embodiment the components (such as the light source 210, the light sensing element 220, the light guide strip 230 and the light-filtering component 240) of the optical touch module are disposed on the supporting part 330 of the base 300. And thus, in the embodiment of the plate 260 being a display panel, a glass substrate is no longer required to be disposed between the optical touch module and the display panel; and consequently, the optical touch apparatus 200 can be prevented from having an affected light transmittance as well as having light reflections.

It is to be noted that, the components of the aforementioned optical touch module are not limited to the light source 210, the light sensing element 220, the light guide strip 230 and the light-filtering component 240. For example, the light guide strip 230 can be replaced with a reflective strip, a flat mirror or other types of suitable component in other embodiments. In addition, it is to be noted that the supporting parts 330 of the base 300 each are not necessary to have a same structure in the present invention. In one embodiment, the base 300 can have only one supporting part 330 which is constituted by the first wall 331, the second wall 332 and the third wall 333.

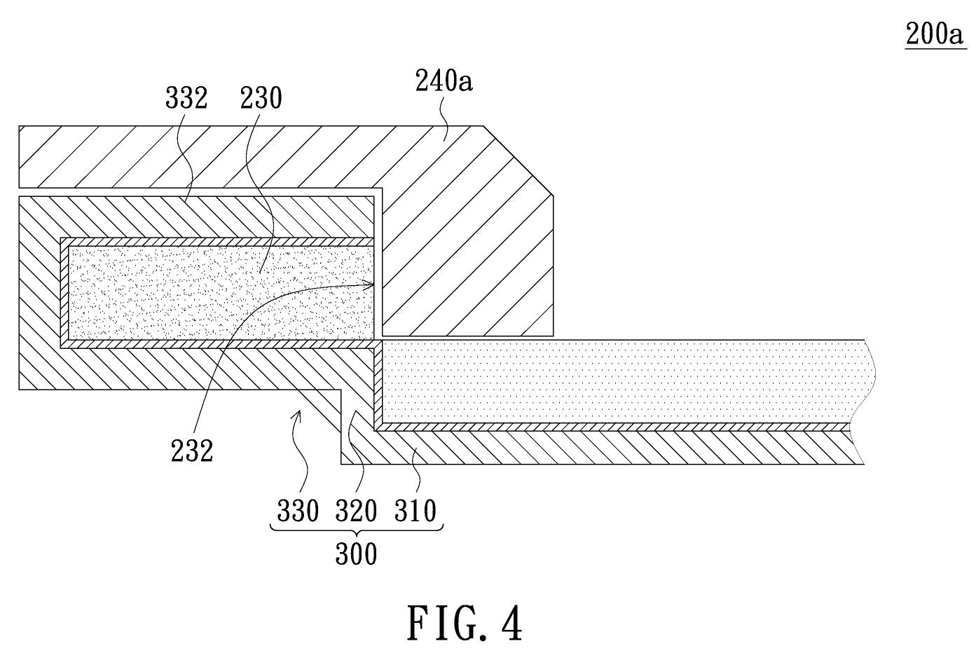

FIG. 4 is a schematic partial cross-sectional view of an optical touch apparatus in accordance with another embodiment of the present invention. As shown, the optical touch apparatus 200a in this embodiment has a structure similar to that of the aforementioned optical touch apparatus 200; the main difference between the two is in the light filtering component. Specifically, the light filtering component 240a of the optical touch apparatus 200a is configured to cover the second wall 332 of the supporting part 330 and the light-emission surface 232 of the light guide strip 230. Based on this specific structure, the light filtering component 240a not only provides the light filtering function but also can function as an appearance component of the optical touch apparatus 200a; in other words, due to the light filtering component 240a, the optical touch apparatus 200a does not need an extra appearance component to cover the second wall 332 of the supporting part 330.

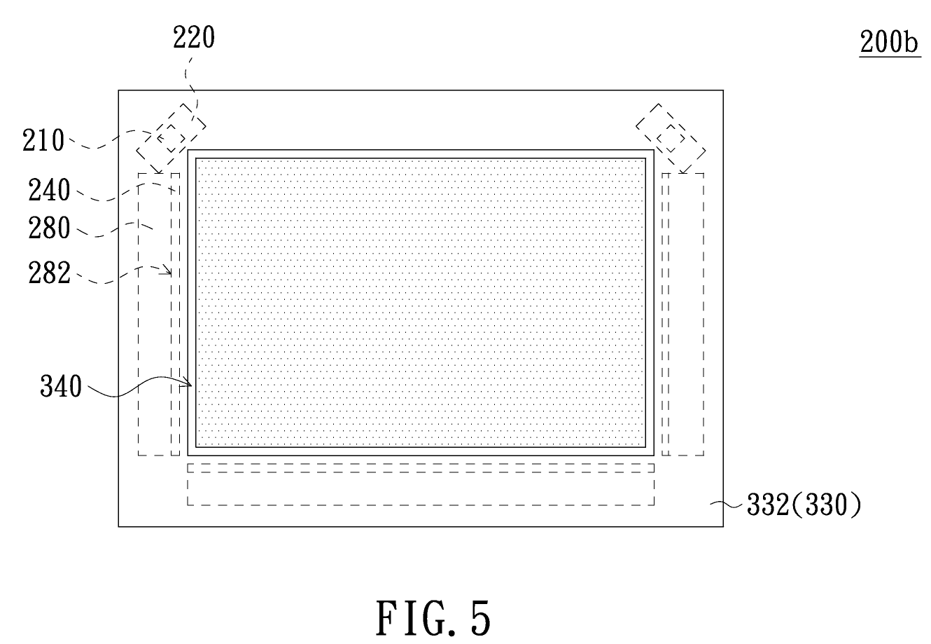

FIG. 5 is a schematic top view of an optical touch apparatus in accordance with another embodiment of the present invention. As shown, the optical touch apparatus 200b in this embodiment has a structure similar to that of the aforementioned optical touch apparatus 200; the main difference between the two is that the optical touch apparatus 200b adopts a reflective strip 280 instead of the light guide strip 230 adopted in the optical touch apparatus 200. The reflective strip 280 has a reflective surface 282 configured to face to the accommodation space 340; and the light filtering component 240 is disposed on the reflective strip 280. In addition, the light source 210 is, for example, superposed on the light sensing element 220. Moreover, it is understood that in this embodiment the light filtering component 240 can also be replaced with the light filtering component 240a (shown in FIG. 4) so as to cover the second wall 332 of the supporting part 330 and the reflective surface 332 of the reflective strip 230.

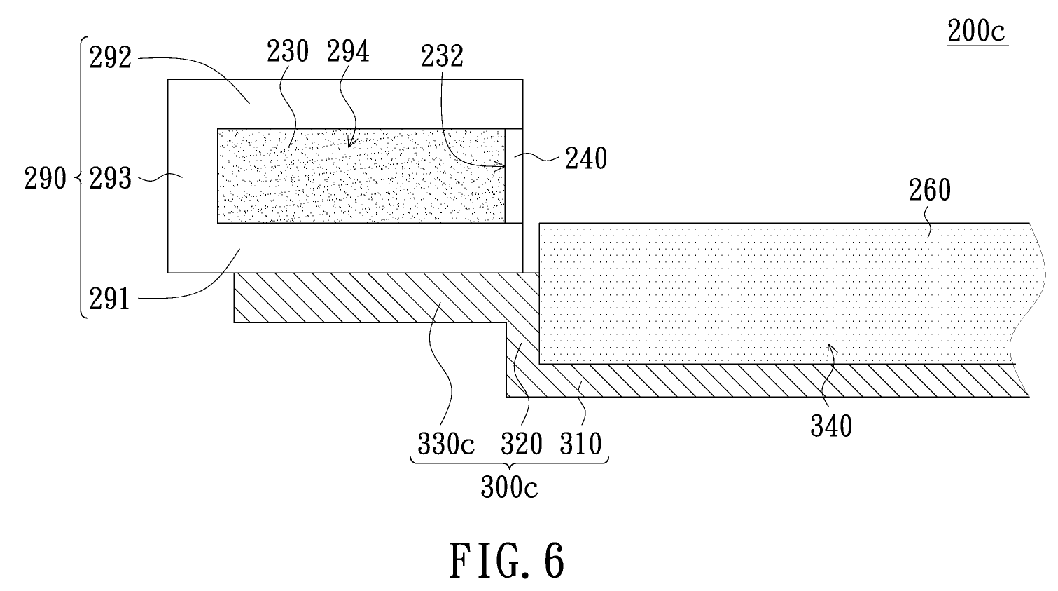

FIG. 6 is a schematic partial cross-sectional view of an optical touch apparatus in accordance with another embodiment of the present invention. As shown, the optical touch apparatus 200c in this embodiment has a structure similar to that of the aforementioned optical touch apparatus 200; the main difference between the two is in the supporting part of a base. In the optical touch apparatus 200c, the supporting part 330c of the base 300c has a plate structure. In addition, the optical touch apparatus 200c may further include a reflective film 290 disposed on the supporting part 330c. The reflective film 290 includes a fourth wall 291, a fifth wall 292 and a sixth wall 293. Specifically, the fourth wall 291 is disposed on the supporting part 330c; the fourth wall 291 and the fifth wall 292 are opposite to each other; and the sixth wall 293 is connected between the fourth wall 291 and the fifth wall 292. The fourth wall 291, the fifth wall 292 and the sixth wall 293 corporately form an accommodation groove 294, in which the light guide strip 230 is disposed. The light filtering component 240 is disposed on the light-emission surface 232 of the light guide strip 230. Moreover, it is understood that in another embodiment the light filtering component 240 can also be replaced with the light filtering component 240a (shown in FIG. 4) so as to cover the fifth wall 292 and the light-emission surface 232 of the light guide strip 230. In addition, the light guide strip 230 in FIG. 6 can be replaced with a reflective strip; and a reflective film can be disposed on the surfaces (facing to the accommodation space 340) of the bottom wall 310 and the sidewalls 320 of the base 300c.

In summary, because the base in the optical touch apparatus according to the present invention includes the supporting part configured to support the components (such as the light source, the light sensing element, the light guide strip and the light filtering component) of the optical touch module, the aforementioned components can be positioned more accurately and accordingly the assembly efficiency of the optical touch apparatus is improved. Additionally, in the case of the optical touch apparatus including a display panel, a glass substrate is no longer required to be disposed between the optical touch module and the display panel; and consequently, a lower light transmittance and light reflections can be avoided.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch apparatus, comprising:
a base constituted by a bottom wall, a plurality of sidewalls and at least one supporting part, wherein the sidewalls are connected to the bottom wall, the sidewalls and the bottom wall corporately form an accommodation space, the at least one supporting part is connected to at least one of the sidewalls and extends from at least one of the connected sidewall(s) in a direction away from the accommodation space;
a light source disposed on the at least one supporting part; and
a light sensing element disposed on the at least one supporting part.

2. The optical touch apparatus according to claim 1, wherein the supporting part comprises a first wall, a second wall and a third wall, the first wall is connected to its corresponding sidewall, the first wall and the second wall are opposite to each other, the third wall is connected between the first wall and the second wall, and the first wall, the second wall and the third wall corporately form an accommodation groove.

3. The optical touch apparatus according to claim 2, further comprising a light guide strip disposed in the accommodation groove, wherein the light guide strip has a light-incidence surface and a light-emission surface adjacent to the light-incidence surface, the light-emission surface is configured to face to the accommodation space, and the light source is disposed beside the light-incidence surface.

4. The optical touch apparatus according to claim 3, further comprising a light filtering component disposed on the light-emission surface of the light guide strip.

5. The optical touch apparatus according to claim 3, further comprising a light filtering component configured to cover the second wall and the light-emission surface of the light guide strip.

6. The optical touch apparatus according to claim 2, further comprising a reflective strip disposed in the accommodation groove, wherein the reflective strip has a reflective surface facing to the accommodation space.

7. The optical touch apparatus according to claim 6, further comprising a light filtering component disposed on the reflective surface of the reflective strip.

8. The optical touch apparatus according to claim 6, further comprising a light filtering component configured to cover the second wall and the reflective surface of the reflective strip.

9. The optical touch apparatus according to claim 2, further comprising a reflective layer disposed on the surfaces, facing to the accommodation groove, of the first wall, the second wall and the third wall.

10. The optical touch apparatus according to claim 1, wherein the supporting part has a plate structure.

11. The optical touch apparatus according to claim 10, further comprising a reflective film disposed on the plate, wherein the reflective film comprises a fourth wall, a fifth wall and a sixth wall, the fourth wall is disposed on the plate, the fourth wall and the fifth wall are opposite to each other, the sixth wall is connected between the fourth wall and the fifth wall, and the fourth wall, the fifth wall and the sixth wall corporately form an accommodation groove.

12. The optical touch apparatus according to claim 11, further comprising a light guide strip disposed in the accommodation groove, wherein the light guide strip has a light-incidence surface and a light-emission surface adjacent to the light-incidence surface, the light-emission surface is configured to face to the accommodation space, and the light source is disposed beside the light-incidence surface.

13. The optical touch apparatus according to claim 12, further comprising a light filtering component disposed on the light-emission surface of the light guide strip.

14. The optical touch apparatus according to claim 12, further comprising a light filtering component configured to cover the fifth wall and the light-emission surface of the light guide strip.

15. The optical touch apparatus according to claim 1, wherein the base is made of a metal plate processed by a stamping production mean.

16. The optical touch apparatus according to claim 1, further comprising a display panel disposed in the the accommodation space.

17. The optical touch apparatus according to claim 1, further comprising a reflective layer disposed on surfaces of the bottom wall and the sidewalls, wherein the surfaces face to the accommodation space.
